(19) United States
(12) Patent Application Publication
(10) Pub. No.: US 2017/0048224 A1
(43) Pub. Date: Feb. 16, 2017

(54) AUTHENTICATION DEVICE, TERMINAL DEVICE, AUTHENTICATION METHOD, AND NON-TRANSITORY COMPUTER READABLE STORAGE MEDIUM

(71) Applicant: YAHOO JAPAN CORPORATION, Tokyo (JP)

(72) Inventors: Teruhiko TERAOKA, Tokyo (JP); Hidehito GOMI, Tokyo (JP)

(73) Assignee: YAHOO JAPAN CORPORATION, Tokyo (JP)

(21) Appl. No.: 15/201,025

(22) Filed: Jul. 1, 2016

(30) Foreign Application Priority Data
Aug. 11, 2015 (JP) 2015-159109

(51) Int. Cl. H04L 29/06; H04W 12/06

(52) U.S. Cl. CPC H04L 63/08; H04L 63/107; H04W 12/06

(57) ABSTRACT

An authentication device according to the present application includes an acquisition unit and an authentication unit. The acquisition unit acquires use states in a plurality of terminal devices used by a user. The authentication unit authenticates the user based on a combination of the use states of the terminal devices acquired by the acquisition unit. For example, the acquisition unit acquires the use states of the terminal devices within a predetermined period of time until a time when a request for authentication is received, and the authentication unit authenticates the user based on the combination of the use states of the terminal devices within the predetermined period of time acquired by the acquisition unit.

### CROSS-REFERENCE TO RELATED APPLICATION(S)

The present application claims priority to and incorporates by reference the entire contents of Japanese Patent Application No. 2015-159109 filed in Japan on Aug. 11, 2015.

### BACKGROUND OF THE INVENTION

1. Field of the Invention

The present invention relates to an authentication device, a terminal device, an authentication method, and a non-transitory computer readable storage medium having stored therein an authentication program.

2. Description of the Related Art

Communication terminal devices (hereinafter, referred to as “terminals”) equipped with various sensors have become common. The sensors mounted in each of the terminals acquire data on a use state of the terminal by converting physical phenomena into digital signals. The data is transmitted to a predetermined server through a network, and is used for various types of information processing.

As a technique for using the data acquired by the terminal, a technique is known in which personal authentication of a user is performed based on behavioral characteristic information on the user operating the terminal (for example, Japanese Patent Application Laid-open Publication No. 2009-175984). Also, a technique is known related to a personal identification method using current position information on a terminal owned by a user (for example, Japanese Patent Application Laid-open Publication No. 2014-149811).

However, the conventional techniques described above have difficulty in ensuring security of authentication. For example, the conventional techniques described above have difficulty in maintaining the security of authentication if the terminal is lost, or if the terminal is used by a third party without the user's consent.

### SUMMARY OF THE INVENTION

It is an object of the present invention to at least partially solve the problems in the conventional technology.

An authentication device according to the present application includes an acquisition unit that acquires use states in a plurality of terminal devices used by a user, and an authentication unit that authenticates the user based on a combination of the use states of the terminal devices acquired by the acquisition unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of authentication processing according to an embodiment;

FIG. 2 is a diagram illustrating a configuration example of an authentication processing system according to the embodiment;

FIG. 3 is a diagram illustrating a configuration example of a user terminal according to the embodiment;

FIG. 4 is a diagram illustrating a configuration example of an authentication device according to the embodiment;

FIG. 5 is a diagram illustrating an example of a use state storage unit according to the embodiment;

FIG. 6 is a diagram illustrating an example of an authentication information storage unit according to the embodiment;

FIG. 7 is a diagram for illustrating an example of the authentication processing performed by an authentication unit according to the embodiment;

FIG. 8 is a flowchart illustrating an authentication processing procedure according to the embodiment;

FIG. 9 is a diagram (1) illustrating a configuration example of the authentication processing system according to a modification of the embodiment;

FIG. 10 is a diagram (2) illustrating a configuration example of the authentication processing system according to another modification of the embodiment; and

FIG. 11 is a hardware configuration diagram illustrating an example of a computer for carrying out functions of the authentication device.

### DETAILED DESCRIPTION OF THE PREFERRED EMBODIMENTS

The following describes in detail modes (hereinafter, called “embodiments”) for providing an authentication device, a terminal device, an authentication method, and a non-transitory computer readable storage medium having stored therein a authentication program according to the present application with reference to the drawings. The embodiments do not limit the authentication device, the terminal device, the authentication method, and the non-transitory computer readable storage medium having stored therein the authentication program according to the present application. The embodiments can be appropriately combined within the scope not causing contradiction in processing details. In the following embodiments, the same portions will be assigned with the same reference numerals, and descriptions thereof will not be repeated.

1. Example of Authentication Processing

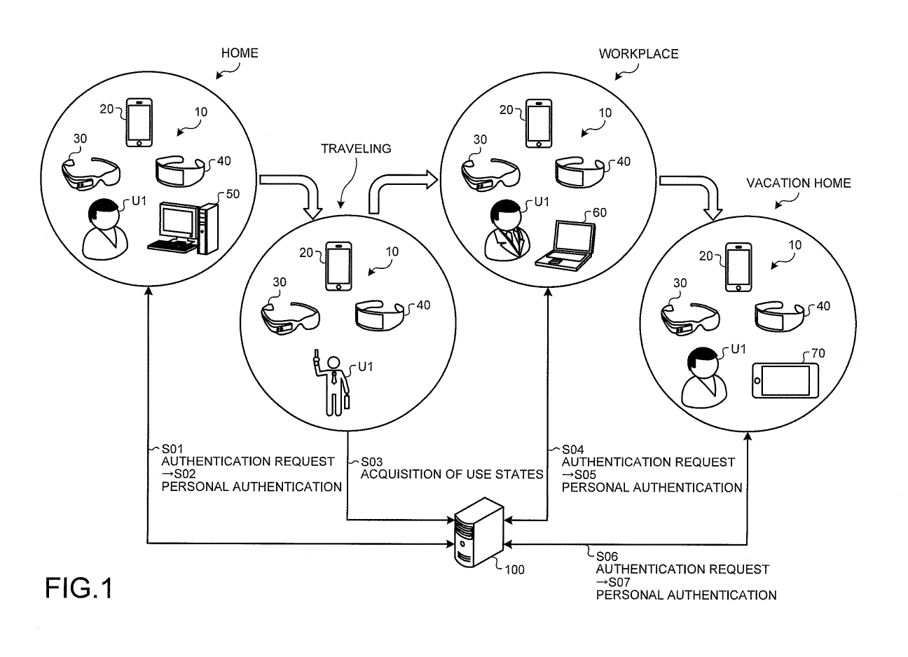

An example of authentication processing according to an embodiment will first be described with reference to FIG. 1. FIG. 1 is a diagram illustrating the example of the authentication processing according to the present embodiment. FIG. 1 illustrates the example in which an authentication device 100 according to the present application performs the authentication processing of a user who uses a plurality of terminals.

The authentication device 100 is a server device that acquires information transmitted from the terminals and performs authentication of the user based on the acquired information. The information acquired by the authentication device 100 is use states of the terminals that include, for example, histories (logs) of operations of the terminal by the user, data acquired by, for example, sensors in the terminals, and information on communications performed by the terminals.

The authentication device 100 acquires information from the terminals associated with the user. The terminals associated with the user (hereinafter, referred to as “user terminals 10”) refer to, for example, terminals owned by the user or terminals used by the user, and may be portable mobile terminals or terminals placed at certain places. The authentication device 100 performs authentication of the user based on a combination of the use states acquired from the user terminals 10. The following describes the example of the authentication processing performed by the authentication device 100 along the processing flow.

FIG. 1 illustrates states that a user U1 is in and the user terminals 10 that can be used by the user U1 in those states. For example, FIG. 1 illustrates that the user U1 can use a smartphone 20, smartglasses 30, a smartwatch 40, and a desktop computer 50 as the user terminals 10 when the user U1 is at “home”. FIG. 1 illustrates that the user U1 can use the smartphone 20, the smartglasses 30, and the smartwatch 40 as the user terminals 10 when the user U1 is “traveling”. FIG. 1 illustrates that the user U1 can use the smartphone 20, the smartglasses 30, the smartwatch 40, and a laptop 60 as the user terminals 10 when the user U1 is at a “workplace”. FIG. 1 illustrates that the user U1 can use the smartphone 20, the smartglasses 30, the smartwatch 40, and a tablet computer 70 as the user terminals 10 when the user U1 is at a “vacation home”. Hereinafter, when the terminals need not be distinguished from one another, the terminals, such as the smartphone 20, may be collectively referred^{.}to as the user terminals 10.

Each of the user terminals 10 acquires information to be transmitted to the authentication device 100 at predetermined intervals of time, or records the information at a time when a particular event (such as an operation by the user) occurs, and holds the information for a predetermined period. The user terminal 10 transmits the held information to the authentication device 100 at predetermined times. The authentication device 100 acquires and holds the information transmitted from each of the user terminals 10. In the example illustrated in FIG. 1, the authentication device 100 is assumed to have acquired the histories of the use states from the user terminals 10 associated with the user U1 for a certain period (such as for the previous several months). The authentication device 100 may acquire the use states by crawling through the user terminals 10 at predetermined intervals of time, instead of by receiving the use states transmitted from the user terminals 10.

In the example of FIG. 1, the user U1 tries to log in to the desktop computer 50 placed at home. At this time, the user U1 is asked by the desktop computer 50 to be personally authenticated. That is, to prevent any user other than the user U1 from logging in, the desktop computer 50 checks whether the user trying to log in is the user U1. At the time when the user U1 has tried to log in, the desktop computer 50 transmits, to the authentication device 100, information that the authentication is requested (Step S01).

The authentication device 100 receives, from the desktop computer 50, the information that the authentication is requested. The authentication device 100 refers to the use state of the desktop computer 50 held in the authentication device 100. Based on the past history of the use state of the desktop computer 50, the authentication device 100 determines that the user who has logged in to the desktop computer 50 in the past is a user who uses the smartphone 20, the smartglasses 30, and the smartwatch 40. This determination is made based on a combination of the use states of the user terminals 10, for example, that the smartphone 20, the smartglasses 30, and the smartwatch 40 were present at the same time at the same place when the desktop computer 50 was used in the past. Alternatively, the determination may be made based on such use states indicating that communications were established among the smartphone 20, the smartglasses 30, and the smartwatch 40 that were present at short distances (such as within several tens of meters) when the desktop computer 50 was used in the past.

The authentication device 100 acquires the use states of the desktop computer 50 and the user terminals 10 present around the desktop computer 50 at the time when the authentication request is received from the desktop computer 50. For example, the authentication device 100 acquires the use states indicating that the smartphone 20, the smartglasses 30, and the smartwatch 40 are present at short distances from the desktop computer 50 to which the login is being tried. Based on the combination of the use states of the smartphone 20, the smartglasses 30, the smartwatch 40, and the desktop computer 50, the authentication device 100 determines a certain degree of reliability that the user trying to log in is highly likely to be the user U1. In this manner, the authentication device 100 authenticates the user U1 (Step S02).

That is, the authentication device 100 authenticates the user 111 by comparing the past use state of the desktop computer 50 used with the use state of the desktop computer 50 at the time when the authentication has been tried, based on the combination including the use states of the surrounding user terminals 10.

In this manner, by performing the authentication based on not only the use state of the terminal as a target of authentication for, for example, the login, but also the use states of a plurality of terminals, the authentication device 100 can perform the more secure and more reliable personal authentication than by using information on a single terminal. The authentication device 100 acquires the use states of the surrounding user terminals 10 at the time when the information that the authentication is requested by the desktop computer 50 is received, and performs the authentication based on the acquired information. At this time, if, for example, position information on the user terminals 10 and information on the communication state with other terminals are acquired, and if a certain degree of reliability for authentication of the user U1 is obtained based on the acquired information, the authentication device 100 need not ask the user U1 to perform an authentication operation, such as password input. In this manner, the authentication device 100 reduces an effort for the authentication operation.

The authentication device 100 can perform authentication of the user U1 based on a combination of various types of information acquirable from the user terminals 10. For example, a situation will be described where the user U1 goes out from home toward the workplace. At this time, the authentication device 100 acquires the use states of the smartphone 20, the smartglasses 30, and the smartwatch 40 carried by the user U1 traveling by train (Step S03). The authentication device 100 acquires, for example, a transition of the position information on the smartphone 20, the smartglasses 30, and the smartwatch 40. The position information is acquired based on, for example, data detected by a Global Positioning System (GPS) receiver included in, for example, the smartphone 20.

After reaching the workplace, the user U1 tries to log in to the laptop 60 used at the workplace. At this time, the laptop 60 transmits, to the authentication device 100, information that authentication is requested (Step SO4).

The authentication device 100 receives the information that the laptop 60 is requested for authentication. The authentication device 100 refers to the use state of the laptop 60 held in advance. Based on the past use state of the laptop 60, the authentication device 100 determines that the user using the laptop 60 is a user who uses the smartphone 20, the smartglasses 30, and the smartwatch 40, and travels to the workplace through the same path nearly every day.

The authentication device 100 acquires the use states of the smartphone 20, the smartglasses 30, and the smartwatch 40 at present time. At this time, the authentication device 100 acquires the use states indicating that the smartphone 20, the smartglasses 30, and the smartwatch 40 have traveled to a surrounding area of the laptop 60 at the same time and through the same path. In this case, based on the combination of the use states of the user terminals 10, the authentication device 100 determines that a certain degree of reliability is present that the user trying to log in to the laptop 60 is the user U1. In this manner, the authentication device 100 authenticates the user U1 (Step S05).

The authentication device 100 may perform the personal authentication based on similar use states acquired at certain intervals of time. For example, the user U1 is assumed to have a habit to spend every weekend at the vacation home. The user U1 travels to the vacation home with the smartphone 20, the smartglasses 30, and the smartwatch 40. After reaching the vacation home, the user U1 tries to log in to the tablet computer 70 placed at the vacation home in advance. The tablet computer 70 transmits, to the authentication device 100, information that authentication is requested (Step S06).

The authentication device 100 receives the information that the tablet computer 70 is requested for authentication. The authentication device 100 refers to the use state of the tablet computer 70 held in advance. Based on the past use state of the tablet computer 70, the authentication device 100 determines that the user using the tablet computer 70 is a user who uses the smartphone 20, the smartglasses 30, and the smartwatch 40, and travels to the vacation home at certain intervals of time.

The authentication device 100 acquires the use states of the smartphone 20, the smartglasses 30, and the smartwatch 40. Specifically, the authentication device 100 acquires the use states indicating that the smartphone 20, the smartglasses 30, and the smartwatch 40 have traveled to the vicinity of the tablet computer 70 at the same time and at intervals of time similar to those in the histories of the acquired use states. In this case, based on the combination of the use states of the user terminals 10, the authentication device 100 determines that a certain degree of reliability is present that the user trying to log in to the tablet computer 70 is the user U1. In this manner, the authentication device 100 authenticates the user U1 (Step S07).

As described above, the authentication device 100 according to the present embodiment acquires the use states in the user terminals 10 used by the user. The authentication device 100 authenticates the user based on the combination of the acquired use states of the user terminals 10.

In this manner, the authentication device 100 according to the present embodiment improves the reliability of the authentication. For example, if a third party intentionally or accidentally acquires a terminal of another user and performs any authentication activity, the authentication device 100 performs the authentication through the inquiry to the use states of the terminals, so that the authentication device 100 can reject personal authentication requested through use of a single terminal. In this manner, the authentication device 100 can determine whether the authentication activity is illegally performed. The authentication device 100 acquires the use states of the terminals of the user so as to obtain information on, for example, the transition of the position information observed routinely and the communication states among the terminals. The authentication device 100 determines a correlation of these pieces of information with the terminals used by the user trying to be authenticated, and thereby can determine the reliability that the user trying to be authenticated is a proper user with high probability. Moreover, the authentication device 100 automatically acquires the use states of the terminals, and thereby can perform the authentication without requiring an effort of the user. This means that the user can go through the correct authentication processing without a particular effort, such as password input. In this manner, the authentication device 100 can reduce the burden related to the authentication while maintaining the security of authentication.

The example of FIG. 1 described above has illustrated the example in which the authentication device 100 acquires the use states and does not perform the authentication processing at Step S03. However, the authentication device 100 is not limited to this example. For example, the authentication processing may be performed during the traveling, and authentication processing (such as release of operation lock) may be performed not only for the user terminals 10 placed at various places, but also for the mobile terminals.

2. Configuration of Authentication Processing System

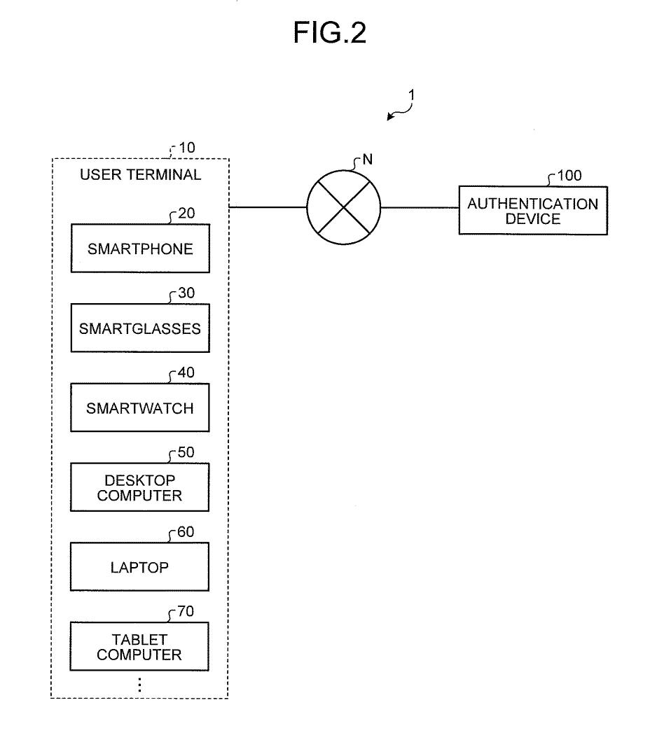

The following describes a configuration of an authentication processing system 1 including the authentication device 100 according to the present embodiment with reference to FIG. 2. FIG. 2 is a diagram illustrating a configuration example of the authentication processing system 1 according to the present embodiment. As illustrated in FIG. 2, the authentication processing system 1 according to the present embodiment includes the user terminals 10 and the authentication device 100. As illustrated in FIG. 2, the user terminals 10 include, for example, the smartphone 20, the smartglasses 30, the smartwatch 40, the desktop computer 50, the laptop 60, and the tablet computer 70. These various devices are connected in a wired or wireless manner through a network N so as to be capable of communicating with one another.

As described above, the user terminals 10 are information processing terminals, such as a desktop personal computer (PC), a laptop PC, a tablet computer, a mobile phone including a smartphone, and a personal digital assistant (PDA). The user terminals 10 also include wearable devices that are eyeglass-type and wristwatch-type information processing terminals. The user terminals 10 may further include various smart devices having information processing functions. For example, the user terminals 10 may include smart home devices such as televisions (TVs), refrigerators, and vacuum cleaners, smart vehicles such as automobiles, drones, and home robots.

Each of the user terminals 10 stores the use state indicating that the terminal has been used according to operations by the user and functions included in the user terminal 10. The user terminal 10 stores, for example, information on switching on/off of the power and on/off of the screen (for example, operations to cancel a sleep state). The user terminal 10 incorporates various sensors. For example, the user terminal 10 includes sensors for measuring various physical quantities, such as positions, accelerations, temperatures, gravity, rotations (angular velocities), illuminance, the earth's magnetism, pressure, proximity, humidity, and rotation vectors. The user terminal 10 acquires information measured by the various sensors according to the use state of the user. The user terminal 10 may acquire various types of information by communicating with external systems, such as the GPS mentioned above. The user terminal 10 transmits the acquired information to the authentication device 100.

As described above, the authentication device 100 is a server device that acquires the use states of the user terminals 10, such as the operation histories and the information detected by the sensors, and that authenticates the user based on the combination of the acquired use states of the user terminals 10.

3. Configuration of User Terminal

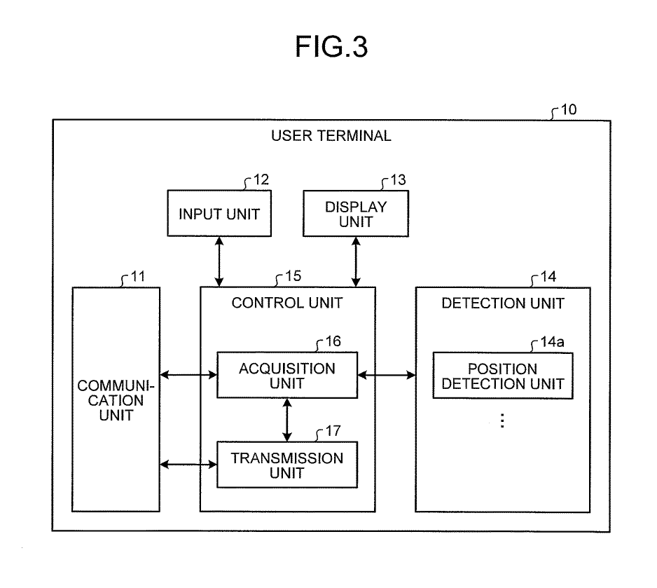

The following describes a configuration of the user terminal 10 according to the present embodiment with reference to FIG. 3. FIG. 3 is a diagram illustrating a configuration example of the user terminal 10 according to the present embodiment. As illustrated in FIG. 3, the user terminal 10 includes a communication unit 11, an input unit 12, a display unit 13, a detection unit 14, and a control unit 15.

The communication unit 11 is connected in a wired or wireless manner to the network N, and transmits and receives information to and from the authentication device 100. The communication unit 11 is provided, for example, using a network interface card (NIC).

The input unit 12 is an input device that receives various operations from the user. For example, the input unit 12 is provided using, for example, operation keys provided on the user terminal 10. The display unit 13 is a display device for displaying various types of information. For example, the display unit 13 is provided using, for example, a liquid crystal display. When a touchscreen panel is used in the user terminal 10, a part of the input unit 12 is integrated with the display unit 13.

The detection unit 14 detects various types of information on the user terminal 10. Specifically, the detection unit 14 detects a physical state of the user terminal 10 as user information. In the example illustrated in FIG. 3, the detection unit 14 includes a position detection unit 14a.

The position detection unit 14a acquires a current position of the user terminal 10. Specifically, the position detection unit 14a receives radio waves emitted from GPS satellites, and acquires the position information (such as a latitude and a longitude) representing the current position of the user terminal 10 based on the received radio waves. The position detection unit 14a may acquire the position information using a different method. For example, if the user terminal 10 has the same function as that of a contactless IC card used at, for example, station ticket gates and shops (or if the user terminal 10 has a function to read the history of a contactless IC card), the user terminal 10 records information on, for example, settlement of fare at stations and positions where the user terminal 10 was used. The position detection unit 14a detects this information as the position information. When the user terminal 10 communicates with a particular access point, the position detection unit 14a may detect the position information acquirable from the access point.

The detection unit 14 may include not only the position detection unit 14a, but also various devices that detect various states of the user terminal 10. The detection unit 14 may include, for example, a microphone that collects sound around the user terminal 10, an illuminance sensor that detects illuminance around the user terminal 10, an acceleration sensor (or, for example, a gyro sensor) that detects physical motion of the user terminal 10, a humidity sensor that detects humidity around the user terminal 10, and a geomagnetic sensor that detects a magnetic field at a location of the user terminal 10. The detection unit 14 may use the functions of the sensors to detect various types of information. For example, the detection unit 14 may use the function of the acceleration sensor to detect a step count of the user using the user terminal 10. The detection unit 14 may use the function of the acceleration sensor to detect motion information indicating, for example, whether the user terminal 10 is moving or stationary, at certain intervals of time, or each time the user terminal 10 moves. The detection unit 14 may further have a function to detect biological information, such as a heart rate and a body temperature, of the user, a function to detect a fingerprint, and a function to detect a position where the user terminal 10 is touched by using an electromagnetic induction method or an electrostatic capacitance method.

The control unit 15 is implemented, for example, by a central processing unit (CPU) or a microprocessor unit (MPU) that executes various programs stored in a storage device in the user terminal 10 using a random access memory (RAM) as a work area. Alternatively, the control unit 15 is implemented, for example, by an integrated circuit, such as an application-specific integrated circuit (ASIC) or a field-programmable gate array (FPGA).

The control unit 15 controls processing to provide the use state of the user terminal 10 to the authentication device 100. For example, the control unit 15 controls execution of an information providing application (hereinafter, referred to as the “app”) to carry out the processing to provide the use state of the user terminal 10. The app may be installed in advance on the user terminal 10, or may be installed on the user terminal 10 by being downloaded from a server device (for example, the authentication device 100 or an external server for providing various applications) according to an operation by the user U1 having the user terminal 10.

As illustrated in FIG. 3, the control unit 15 includes an acquisition unit 16 and a transmission unit 17, and implements or executes functions or operations of information processing to be described below. For example, the control unit 15 executes the above-described app using the RAM as a work area so as to implement the acquisition unit 16 and the transmission unit 17. The internal configuration of the control unit 15 is not limited to the configuration illustrated in FIG. 3, but may be another configuration, provided that information processing to be described later is performed. The connection relation of the processing units included in the control unit 15 is not limited to the connection relation illustrated in FIG. 3, but may be another connection relation.

The acquisition unit 16 acquires the use state. Specifically, the acquisition unit 16 controls the detection unit 14 to acquire the various types of information detected by the detection unit 14 as the use state. For example, the acquisition unit 16 controls the position detection unit 14a to acquire, as the use state, the position information of the user terminal 10 and time information corresponding to the time when the position information is detected.

The present invention is not limited to the above example. The acquisition unit 16 may acquire the various types of information from the devices, such as the sensors, included in the detection unit 14, according to the devices. For example, if the detection unit 14 includes the microphone, the acquisition unit 16 acquires, as the use state, sound collection information representing the loudness of sound collected by the microphone. If the detection unit 14 includes the illuminance sensor, the acquisition unit 16 acquires, as the use state, illuminance information representing the illuminance around the user terminal 10. If the detection unit 14 includes the acceleration sensor, the acquisition unit 16 acquires, as the use state, inclination information representing the inclination of the user terminal 10. If the detection unit 14 includes the humidity sensor, the acquisition unit 16 acquires, as the use state, humidity information representing the humidity around the user terminal 10. If the detection unit 14 includes the geomagnetic sensor, the acquisition unit 16 acquires, as the use state, geomagnetic field information representing the geomagnetic field at the location of the user terminal 10.

The acquisition unit 16 may acquire, as the use state, information on a state of communication performed by the communication unit 11. For example, the acquisition unit 16 acquires communication states of the user terminals 10 with each other. If the user terminal 10 has a phone call function, the acquisition unit 16 may acquire information on, for example, the time when a phone call is made, the destination of the phone call, and the duration of the phone call. If the user terminal 10 has a photographing function, the acquisition unit 16 may acquire information on, for example, the time when a photograph is taken, the position where the photograph is taken, and the duration of the photographing.

Types of the use state to be acquired by the acquisition unit 16 may be appropriately set by the authentication device 100. Specifically, even if the user terminal 10 has a function to acquire a plurality of types of information, the authentication device 100 may make a setting so that information not used in the authentication will not be acquired or not be transmitted to the authentication device 100. Such a setting is controlled, for example, by an app installed on the user terminal 10.

The control unit 15 may determine in advance the timing at which the acquisition unit 16 acquires the various types of user information. For example, the acquisition unit 16 acquires the above-described use state at regular intervals (for example, at intervals of one minute, three minutes, five minutes, one hour, one day, or one week). The authentication device 100 may set the timing at which the acquisition unit 16 acquires the use state. The acquisition unit 16 may acquire the use state at times when predetermined events occur. For example, the acquisition unit 16 acquires the use state according to the timing of the predetermined events, for example, when the screen is turned on or off, when the user performs operations, when the above-described contactless IC card function is used, and when the camera photographing is made.

The transmission unit 17 transmits the use state acquired by the acquisition unit 16 to the authentication device 100. For example, the transmission unit 17 transmits identification information for identifying the user terminal 10, the use state acquired by the acquisition unit 16, and the acquisition date/time at which the use state was acquired by the acquisition unit 16 to the authentication device 100. In this case, the transmission unit 17 may transmit the use state and so on to the authentication device 100 each time the use state is acquired by the acquisition unit 16, or at predetermined intervals of time. For example, the transmission unit 17 transmits the use state to the authentication device 100 at regular intervals (for example, at intervals of one minute, three minutes, five minutes, one hour, one day, or one week). The authentication device 100 may set the timing at which the transmission unit 17 acquires the use state.

4. Configuration of Authentication Device

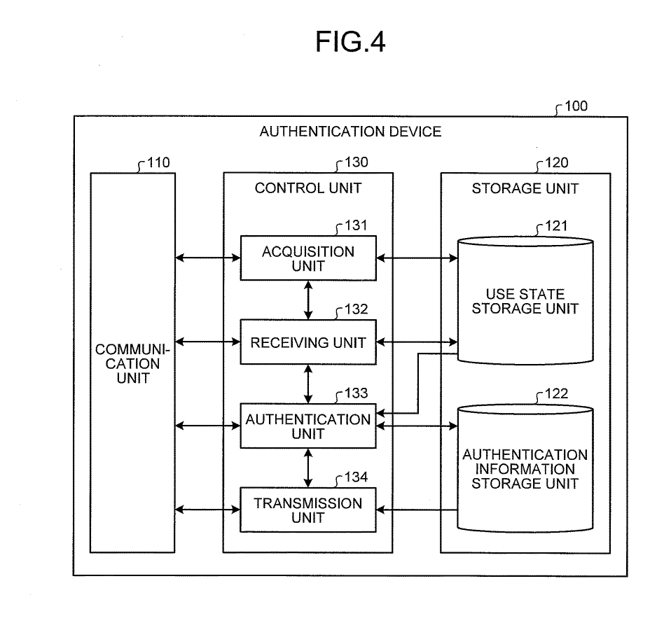

The following describes a configuration of the authentication device 100 according to the present embodiment with reference to FIG. 4. FIG. 4 is a diagram illustrating a configuration example of the authentication device 100 according to the present embodiment. As illustrated in FIG. 4, the authentication device 100 includes a communication unit 110, a storage unit 120, and a control unit 130. The authentication device 100 may include an input unit (such as a keyboard and a mouse) that receives various operations from an administrator and others who use the authentication device 100, and may also include a display unit (such as a liquid crystal display) for displaying various types of information.

Communication Unit 110

The communication unit 110 is provided, for example, using a network interface card (NIC). The communication unit 110 is connected in a wired or wireless manner to the network N, and transmits and receives information to and from the user terminals 10 through the network N.

Storage Unit 120

The storage unit 120 is provided using, for example, a semiconductor memory device, such as a RAM and a flash memory, or a storage device, such as a hard disk and an optical disc. The storage unit 120 includes a use state storage unit 121 and an authentication information storage unit 122.

Use State Storage Unit 121

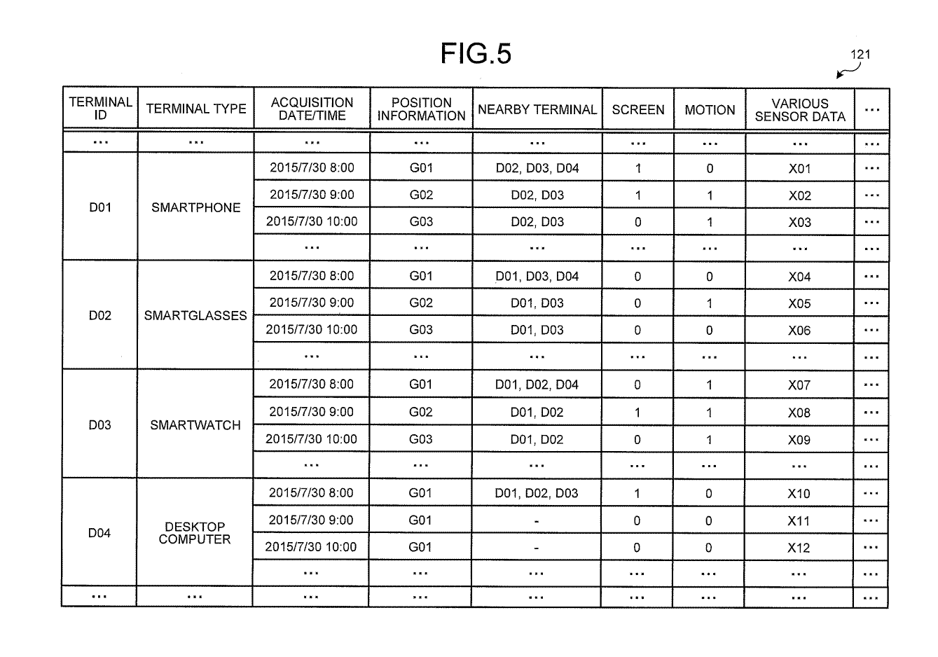

The use state storage unit 121 stores the information on the use states of the user terminals 10. FIG. 5 illustrates an example of the use state storage unit 121 according to the present embodiment. FIG. 5 is a diagram illustrating the example of the use state storage unit 121 according to the present embodiment. In the example illustrated in FIG. 5, the use state storage unit 121 includes items such as “terminal ID”, “terminal type”, “acquisition date/time”, “position information”, “nearby terminals”, “screen”, “motion”, and “various sensor data”.

The “terminal ID” represents the identification information for identifying each of the user terminals 10. The “terminal type” represents the terminal type of each of the user terminals 10. The “acquisition date/time” represents the date and time when the use state transmitted from each of the user terminals 10 was acquired. Although FIG. 5 illustrates the example of acquiring the use states transmitted from the respective user terminals 10 at intervals of one hour, the timing is not limited to this example. That is, the authentication device 100 may acquire the use states at any timing, such as at intervals of ten seconds, one minute, and three minutes.

The “position information” represents the position information on each of the user terminals 10. Although FIG. 5 illustrates the example of storing conceptual information, such as “G01”, as a value represented by the “position information”, information representing, for example, “latitude and longitude” and “address (such as prefecture, city, ward, town, and village)” is actually stored as the position information.

The “nearby terminals” represents other terminals located at short distances from each of the user terminals 10. In FIG. 5, values common to those of the terminal ID are illustrated in the “nearby terminal”. The user terminal 10 determines, for example, terminals that agree on acquired position information to be nearby terminals. The user terminal 10 may alternatively determine a communication partner on the network to be a nearby terminal when a short-range network (such as Bluetooth (registered trademark)) between terminals is established without using external networking equipment or the like as an intermediary. The authentication device 100 may make such a determination. For example, the authentication device 100 detects, from the acquired use states, terminals the position information of which is within a predetermined range, and determines the terminals to be the “nearby terminals”. The authentication device 100 stores the determined information in the use state storage unit 121. If no nearby terminal is detected at the time of acquisition of the use states, the item of the nearby terminal is left blank.

The items “screen” and “motion” represent specific examples of the use states regarding terminal operations on each of the user terminals 10. For example, when a state of “screen on” is observed, “1” is recorded in the item “screen”, or when a state of “screen off” is observed, “0” is recorded in the item “screen”. When a state of “motion on (moving)” is observed, “1” is recorded in the item “motion”, or when a state of “motion off (stationary)” is observed, “0” is recorded in the item “motion”.

The “various sensor data” represents various types of data detected by each of the user terminals 10. Although FIG. 5 illustrates the example of storing conceptual information, such as “X01”, as a value represented by the “various sensor data”, information detected by various sensors is actually stored. For example, values detected by the user terminal 10, such as a value representing the atmospheric pressure, a value representing the loudness of sound, a value representing the illuminance, and values representing the inclination and the acceleration of the user terminal 10, are appropriately stored as the various sensor data.

That is, FIG. 5 illustrates the example in which, in the case of the user terminal 10 identified by the terminal ID “D01”, the terminal type is “smartphone”, the use states transmitted to the authentication device 100 at “Jul. 30, 2015 8:00” are that the position information is “G01”, the “nearby terminals” are “D02, D03, and D04”, the screen is “on”, the motion is “off”, and the various sensor data is “X01”.

Authentication information storage unit 122

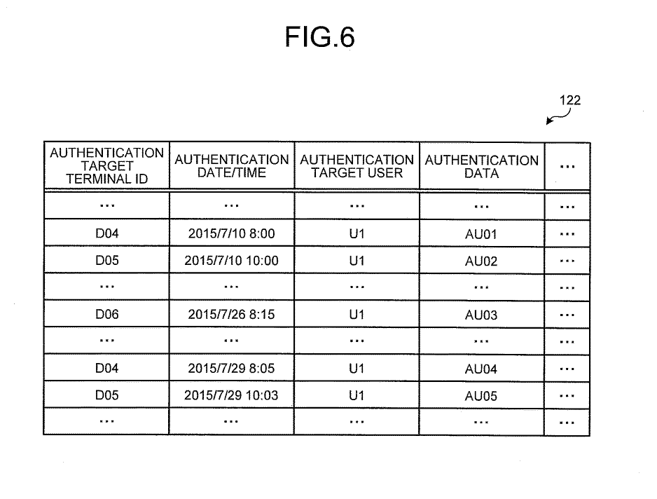

The authentication information storage unit 122 stores information on the authentication. FIG. 6 illustrates an example of the authentication information storage unit 122 according to the present embodiment. FIG. 6 is a diagram illustrating the example of the authentication information storage unit 122 according to the present embodiment. As illustrated in FIG. 6, the authentication information storage unit 122 includes items such as “authentication target terminal ID”, “authentication date/time”, “authentication target user”, and “authentication data”.

The “authentication target terminal ID” represents the information for identifying each of the user terminals 10 on which the authentication was requested. The identification information used as the authentication target terminal ID is common to the terminal ID of FIG. 5. The “authentication date/time” represents the date and time when the personal authentication processing was performed on the user terminal 10 on which the authentication was requested.

The “authentication target user” represents information for identifying the user subjected to the authentication processing. The “authentication data” represents data used for the authentication processing. Although FIG. 6 illustrates the example of storing conceptual information, such as “AU01”, as a value represented by the “authentication data”, the use state of each of the user terminals 10 related to the authentication target user, that is, various types of information, such as the sensor data, acquired as the use state, the combination of the use states, a combination of user terminals 10 from which use states have been acquired, and a result of whether the authentication was successful are actually stored as the authentication data.

That is, FIG. 6 illustrates the example in which, in the case of the user terminal 10 identified by the authentication target terminal ID “D04”, the user who was subjected to the authentication at “Jul. 10, 2015 8:00” and was authenticated in the authentication processing is “U1”, and the authentication data used in the authentication processing is “AU01”.

Control Unit 130

The control unit 130 is implemented, for example, by a CPU or an MPU that executes various programs (corresponding to an example of the authentication program) stored in a storage device in the authentication device 100 using a RAM as a work area. Alternatively, the control unit 130 is implemented, for example, by an integrated circuit, such as an ASIC and an FPGA.

As illustrated in FIG. 4, the control unit 130 includes an acquisition unit 131, a receiving unit 132, an authentication unit 133, and a transmission unit 134, and implements or executes functions or operations of information processing to be described below. The internal configuration of the control unit 130 is not limited to the configuration illustrated in FIG. 4, but may be another configuration, provided that information processing to be described later is performed. The connection relation of the processing units included in the control unit 130 is not limited to the connection relation illustrated in FIG. 4, but may be another connection relation.

Acquisition Unit 131

The acquisition unit 131 acquires the use states in the user terminals 10 used by the user. Specifically, the acquisition unit 131 acquires the various types of information that has been detected or acquired as the use states by the user terminals 10. The acquisition unit 131 acquires the use states from the user terminals 10 at predetermined intervals of time, and stores the acquired use states in the use state storage unit 121. When the authentication processing is performed, the acquisition unit 131 appropriately acquires information to be used in the authentication processing performed by the authentication unit 133 (to be described later) by newly acquiring the use state of the user terminal 10 trying to perform the authentication processing, or by accessing the use state storage unit 121.

When the acquisition unit 131 acquires the information, at least one of the user terminals 10 from which the use state is acquired by the acquisition unit 131 may be a mobile terminal that is portable by the user. The acquisition unit 131 can acquire the position information of the user and the transition of the position information by acquiring the use state of the mobile terminal carried by the user, and thereby can acquire useful information for authenticating the user more easily than acquiring the information from a terminal placed at a certain place.

The acquisition unit 131 may acquire the use states of the user terminals 10 within a predetermined period of time. For example, the acquisition unit 131 acquires the use states in the previous one hour, as the predetermined period of time, before the time when the authentication processing was tried by the user. The acquisition unit 131 may further acquire the use states at a predetermined time corresponding to the time when the authentication processing was tried. For example, if the time when the authentication processing was tried is “8:00” on “Monday”, the acquisition unit 131 acquires the use state of each of the user terminals 10 at “8 o'clock” on “Monday” a week before the time. In this manner, the acquisition unit 131 acquires the use states in the corresponding time periods, so that the authentication unit 133 (to be described later) can perform the authentication processing by, for example, comparing the use states between corresponding time periods.

The acquisition unit 131 acquires the use states of the user terminals 10 within a predetermined geographical area. For example, the acquisition unit 131 acquires the use states of other terminals in an area, as the predetermined geographical area, within several meters from the user terminal 10 on which the authentication processing was tried. Alternatively, the acquisition unit 131 refers to the position information among the use states acquired from the user terminals 10, and extracts user terminals 10 included in the predetermined geographical area. Based on the use states of the extracted user terminals 10, the acquisition unit 131 acquires the use states of the user terminals 10 within the predetermined geographical area.

The acquisition unit 131 acquires, as the use states, the states of communication among the user terminals 10. Specifically, if the user terminals 10 used by a common user are set to be capable of communicating with one another (for example, files or settings are shared) through a network such as the Internet, the acquisition unit 131 acquires such communication states. The acquisition unit 131 may acquire, as the use states, the communication states in which a local network is established to directly connect the user terminals 10 with one another without using an external server or the like as an intermediary.

The acquisition unit 131 may acquire, from the user terminals 10, information on the user terminals 10 detected by the user terminals 10 themselves as the use states. The information detected by the user terminals 10 themselves refers to, for example, information acquired by the various sensors included in the respective user terminals 10. The acquisition unit 131 may acquire a use state of a function included in each of the user terminals 10. The function included in each of the user terminals 10 is executed, for example, by an app installed on the user terminal 10. Each of the user terminals 10 may have one such function or a plurality of such functions. For example, the information on the on/off state of the screen of the user terminal 10 and on the moving/stationary state of the user terminal 10 detected by the acceleration sensor may also be acquired by a function of an app installed on the user terminal 10. In this case, the user terminal 10 uses the app having a certain sensing function to acquire the use state, such as the on/off state of the screen and the moving/stationary state. The acquisition unit 131 acquires the use state acquired by the app on each of the user terminals 10 from the user terminal 10.

The acquisition unit 131 may acquire the use states at different timings from the user terminals 10. In this case, the acquisition unit 131 acquires, for example, the use states of the user terminals 10 associated with the terminal as a target of authentication by using the acquisition date/time at which one of the user terminals 10 acquired the use state as a key, and integrating, based on the key, the use states acquired from the other user terminals 10.

Receiving Unit 132

The receiving unit 132 receives various types of information. For example, the receiving unit 132 receives the use state transmitted from each of the user terminals 10. The receiving unit 132 receives the information transmitted from the user terminal 10 indicating that the authentication is requested. The receiving unit 132 transmits the received information to the processing units of the control unit 130. The receiving unit 132 may store the received information in the storage unit 120 as appropriate.

Authentication Unit 133

The authentication unit 133 authenticates the user based on the combination of the use states of the user terminals 10 acquired by the acquisition unit 131. Specifically, the authentication unit 133 performs the personal authentication of the user by referring to the combination of the use states of the user terminals 10 related to the authentication in response to the request for authentication received by the receiving unit 132.

For example, the authentication unit 133 authenticates the user based on the combination of the use states acquired by the acquisition unit 131 within the predetermined period of time. Specifically, if the use states in the previous one hour before the time when the authentication processing was tried are acquired, the authentication unit 133 performs the authentication processing based on such information.

For example, in FIG. 1, when the user U1 tries to log in to the laptop 60 at the workplace, the authentication unit 133 refers to the use states in the previous one hour of the smartphone 20, the smartglasses 30, and the smartwatch 40. Then, the authentication unit 133 determines that these user terminals have similar information (such as position information) in the use states in the previous one hour of the terminals. That is, the authentication unit 133 determines that the same user uses the smartphone 20, the smartglasses 30, and the smartwatch 40. Furthermore, the authentication unit 133 refers to the past use state of the laptop 60 serving as the authentication target terminal, and finds therein a history indicating that the laptop 60 has been used by the user U1 who uses the smartphone 20, the smartglasses 30, and the smartwatch 40. At this time, the authentication unit 133 determines that the user currently trying to be authenticated is highly likely to be the user U1, and successfully completes the authentication processing on the laptop 60.

The authentication unit 133 may authenticate the user based on the combination of the use states within the predetermined geographical area. For example, the authentication unit 133 refers to the past use state of the laptop 60, and finds, based on the position information of the terminals, that the smartphone 20, the smartglasses 30, and the smartwatch 40 were located within the predetermined range from the location of the laptop 60. When the request for authentication is received, the authentication unit 133 also determines that the smartphone 20, the smartglasses 30, and the smartwatch 40 are located within the predetermined range from the location of the laptop 60 serving as the authentication target terminal. At this time, the authentication unit 133 determines that the user trying to be authenticated is highly likely to be the user U1 who owns the smartphone 20, the smartglasses 30, and the smartwatch 40, and successfully completes the authentication processing.

The authentication unit 133 may authenticate the user based on a combination of the states of communication of the user terminals 10. For example, the authentication unit 133 refers to a history in the past use state of the laptop 60 indicating that files were shared or a local network was established with the smartphone 20, the smartglasses 30, and the smartwatch 40. When the request for authentication is received, the authentication unit 133 also determines that the smartphone 20, the smartglasses 30, and the smartwatch 40 capable of communicating with the laptop 60 serving as the authentication target terminal are present on the network. At this time, the authentication unit 133 determines that the user trying to be authenticated is highly likely to be the user U1 who owns the smartphone 20, the smartglasses 30, and the smartwatch 40, and successfully completes the authentication processing.

The authentication unit 133 may perform the authentication by optionally combining various use states, such as the time range, the geographical area, and the communication states as described above. For example, the authentication unit 133 may determine identity between the user who handles the user terminals 10 and the user trying to access the terminal as a target of authentication based on a state of periodical communication observed among the user terminals 10, or on a state of periodical communication between the user terminal 10 and a particular access point, acquired until the time of receiving of the request for authentication. Specifically, if there is a history indicating that terminals have accessed the same access point within the previous three hours, the authentication unit 133 determines that the terminals are those used by the same user because the terminals have probably followed the same path, that is, the terminals are highly likely to be terminals having the same position information. The authentication unit 133 may determine that the terminals are used by the same user based on the states of communication in which the user terminals 10 directly communicate with one another without using external networking equipment as an intermediary.

The authentication unit 133 may determine that the terminals are used by the same user by referring to differences and similarities in the position information of the terminals one day before or one week before the time when the authentication was tried. For example, the authentication unit 133 refers to the transition of the position information of the user terminals 10, that is, the information on the activity of the user by combining, for example, the position information of the smartglasses 30 several hours before the time when the authentication was tried with information on passing through the nearest station using a function of the smartphone 20 corresponding to that of the contactless IC card. The authentication unit 133 may refer to a similarity between activity information of the user within a predetermined period of time from the time of receiving of the request for authentication and daily activity information of the user observed routinely. If a similarity equal to or higher than a predetermined threshold is verified, the authentication unit 133 determines the identity of the user who uses the terminals from the combination of the use states of the terminals, and thus can perform the personal authentication of the user. The authentication unit 133 may use the information detected by the user terminal 10 itself using the sensors as appropriate so as to perform the authentication processing exemplified above.

The authentication unit 133 may make association of the user terminals 10 among which the use states are to be combined, using various methods in advance, as described above. For example, the authentication unit 133 may receive the association of the user terminals 10 in advance via an app, based on a manual operation of the user U1. The authentication unit 133 may automatically associate the user U1 with the user terminals 10 if, for example, the user terminals 10 are simultaneously used at a particular location (such as at the home, the workplace, and the vacation home of the user U1) more often than a predetermined threshold. The authentication unit 133 may automatically associate user terminals 10 among which a certain local network is established, with one another.

The authentication unit 133 may use, for example, information inferred from the use states to perform the authentication processing. For example, if correct position information cannot be acquired using, for example, the GPS, the authentication unit 133 may acquire data for inferring a context of the user based on the use states of the user terminals 10. The context refers to a state in which a terminal is used by the user or a state that the user having a terminal is in.

That is, the authentication unit 133 may refer to a daily context, that is, a life pattern of the user based on the use states of the user terminals 10 to determine whether the user trying to be authenticated is a user admitted to, for example, log in to the terminal as a target of authentication. For example, the authentication unit 133 infers a context that the user is at “home” or is “traveling” as illustrated in FIG. 1 based on the combination of the use states of the user terminals 10.

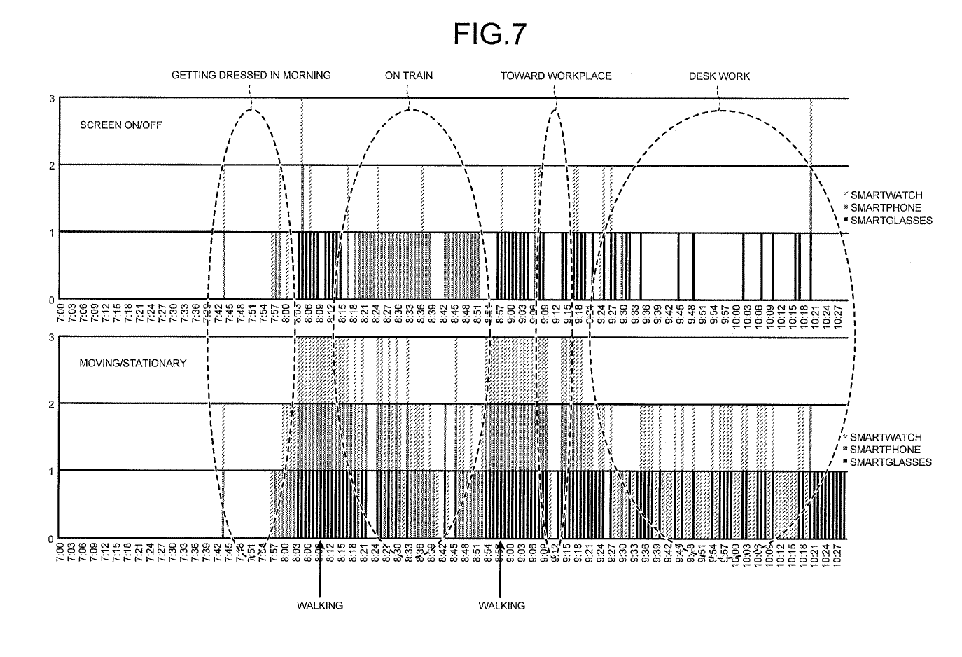

Specifically, the authentication unit 133 refers to the operational information, such as the moving/stationary states of the user terminals 10 and the on/off states of the screens, as the use states. The authentication unit 133 refers to information on times when the user operations were performed. The authentication unit 133 performs the authentication processing of the user who uses the user terminals 10 by inferring the context of the user terminals 10 based on the pieces of information described above. This point will be described with reference to FIG. 7. FIG. 7 is a diagram for illustrating an example of the authentication processing performed by the authentication unit 133 according to the present embodiment.

FIG. 7 illustrates the example displaying, as the use states of the user terminals 10, the use states of “screen on/off” and “moving/stationary” of the smartphone 20, the smartglasses 30, and the smartwatch 40 together with the time information. In FIG. 7, “1” is added upward in the graph when “screen on” or “moving” is observed on each of the user terminal 10. The example depicted in FIG. 7 illustrates the use states of the respective terminals acquired by the acquisition unit 131 during, for example, time “7:00 to 10:27”.

When the use states illustrated in FIG. 7 are present, the authentication unit 133 authenticates the context of the user including the time information for each of the use states. As illustrated in FIG. 7, the authentication unit 133 infers the context based on the combination of the use states of the terminals. For example, the state acquired during time “7:42 to 8:00” in which “screen on” and “moving” are relatively infrequent is inferred to be in a context in which the user is “getting dressed in the morning”. In other words, the authentication unit 133 infers a context in which the user is at “home”.

Thereafter, the terminals of the smartphone 20, the smartglasses 30, and the smartwatch 40 are “moving”, so that the authentication unit 133 infers that the user is “walking” while carrying the terminals. For example, as a result of learning that the terminals are moving physically while the screens of terminals other than the smartglasses 30 are off, and that this is a context repeated every day after “getting dressed in the morning”, the authentication unit 133 infers, based on the acquired data, that the user is in the context of “walking”. After the context of “walking” is observed, the authentication unit 133 infers that the frequent use state of the smartphone 20 acquired during time “8:15 to 8:51” is in a context that the user is “on a train”. Thereafter, the authentication unit 133 infers that the user is in a context of “desk work” at “9:30” or later from the information that the motion and the screen on of terminals other than the smartwatch 40 have decreased in frequency. In other words, the authentication unit 133 can infer a context that the user is at “workplace”.

There can be a case that the accuracy of inference of the context is insufficient with only the screen information and the motion information, in the use states illustrated in FIG. 7. However, the time information is included, and the use states of the same terminals are continuously acquired on a daily basis, so that the authentication unit 133 can increase the accuracy of inference by learning such accumulated pieces of information. In this manner, the authentication unit 133 can accurately infer the context of the user terminals 10 without using the position information acquired from, for example, the GPS. The authentication unit 133 infers the life pattern of the user based on the inferred context. The authentication unit 133 performs the personal authentication of the user based on the similarity in the life pattern. For example, in the example of FIG. 1, when the user tries to log in to the laptop 60 at workplace, the authentication unit 133 infers the context that the user is at “workplace” via being at “home” and “traveling”, based on the use states acquired from the other terminals, that is, the smartphone 20, the smartglasses 30, and the smartwatch 40. Furthermore, the authentication unit 133 determines that this pattern of context is highly similar to the life pattern of the user U1 repeated routinely. Based on this determination, the authentication unit 133 determines that the user currently trying to log in to the laptop 60 at “workplace” is highly likely to be the user U1, and successfully completes the personal authentication.

Furthermore, the authentication unit 133 may variously combine the use states acquired by the acquisition unit 131, and may variously combine the authentication processing exemplified above. The authentication unit 133 may use a known method used for similarity analysis for a correlation between the use states of the user terminals 10 acquired when the authentication is tried and the use states acquired in the past. For example, the authentication unit 133 successfully completes the authentication processing if the use states acquired when the previous authentication was performed or the use states at particular time coincide with the use states of the user terminals 10 acquired when the authentication is tried. In order to improve the security, the authentication unit 133 may successfully complete the authentication processing if the use states of the user terminals 10 acquired when the authentication is tried are highly correlated with the use states acquired at a plurality of times when the authentication processing was performed in the past. In addition, the authentication unit 133 may perform the authentication processing by appropriately using information derived from the acquired use states, such as change amounts and change rates in, for example, the position information, and average values of travel distances.

Regarding the correlation of the use states, the authentication unit 133 may refer to, for example, coincidences in simultaneous use of a plurality of terminals at particular places (such as the home and the workplace) for the user to be authenticated. For example, if a relatively large number of histories are present in which the smartphone 20, the smartglasses 30, and the smartwatch 40 were simultaneously used at a particular location “home of the user U1”, the authentication unit 133 refers to the use states at the time when the authentication processing was tried and the use states in the histories, and determines that the user who has used such terminals is highly likely to be the user U1. Furthermore, the authentication unit 133 may improve the reliability of the various types of information by combining the position information with, for example, the temperature information acquired from the user terminals 10. For example, regarding the position information of a particular user terminal 10, the authentication unit 133 can verify the reliability of the information by cross-checking the time information and the temperature information that have been acquired together. By doing this, if, for example, a third party has maliciously rewritten the position information of the user terminal 10, the authentication unit 133 can determine that a discrepancy is present in the position information when the time information and the temperature information are combined. The authentication unit 133 can perform more secure personal authentication by performing the authentication processing after eliminating the information with low reliability. Regarding the position information, the authentication unit 133 can increase the reliability of the information for use in the authentication by, for example, appropriately combining the various types of information described above, such as by checking whether no difference is found between latitude/longitude information acquired from the GPS and a check-in location acquired by the contactless IC card function.

Transmission Unit 134

The transmission unit 134 transmits various types of information. The transmission unit 134 transmits, for example, the result of the authentication processing performed by the authentication unit 133 to the user terminal 10 that has served as a transmission source transmitting the information indicating that the authentication has been requested.

5. Processing Procedure

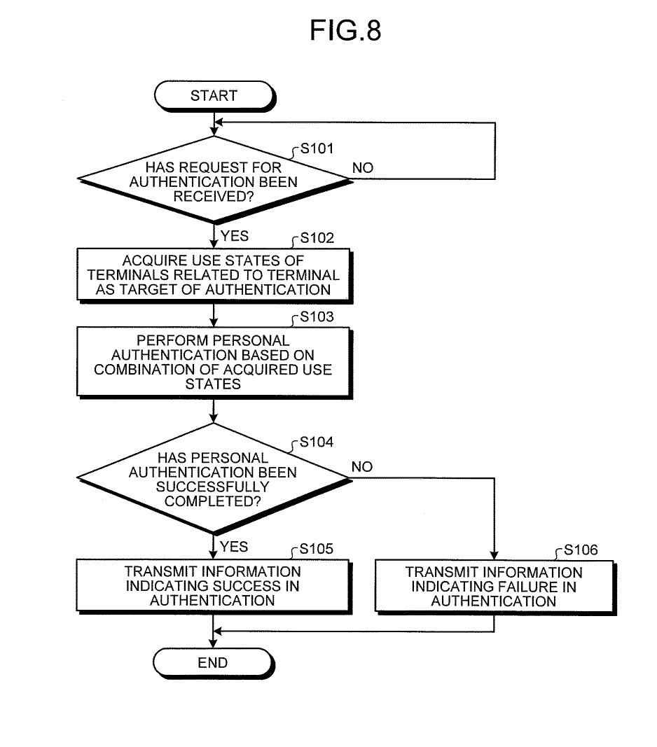

The following describes a procedure of processing by the authentication device 100 according to the present embodiment with reference to FIG. 8. FIG. 8 is a flowchart illustrating the authentication processing procedure according to the present embodiment.

As illustrated in FIG. 8, the receiving unit 132 determines whether a request for authentication has been received from any terminal (Step S101). If no request for authentication has been received (No at Step S101), the receiving unit 132 waits until any request for authentication is received.

If the receiving unit 132 has received a request for authentication (Yes at Step S101), the acquisition unit 131 acquires the use states of terminals related to the terminal as a target of authentication (Step S102).

The authentication unit 133 performs the personal authentication based on the combination of the acquired use states (Step S103). The authentication unit 133 determines whether the personal authentication has been successfully completed (Step S104).

If the personal authentication has been successfully completed (Yes at Step S104), the transmission unit 134 transmits information indicating that the personal authentication has been successfully completed to the terminal as a target of authentication (Step S105). If the personal authentication has not been successfully completed (No at Step S104), the transmission unit 134 transmits information indicating that the personal authentication has failed to the terminal as a target of authentication (Step S106).

6. Modifications

The authentication device 100 described above may be embodied in various forms different from that of the embodiment described above. Thus, the following describes another embodiment of the authentication device 100.

6-1. Configuration of Authentication System

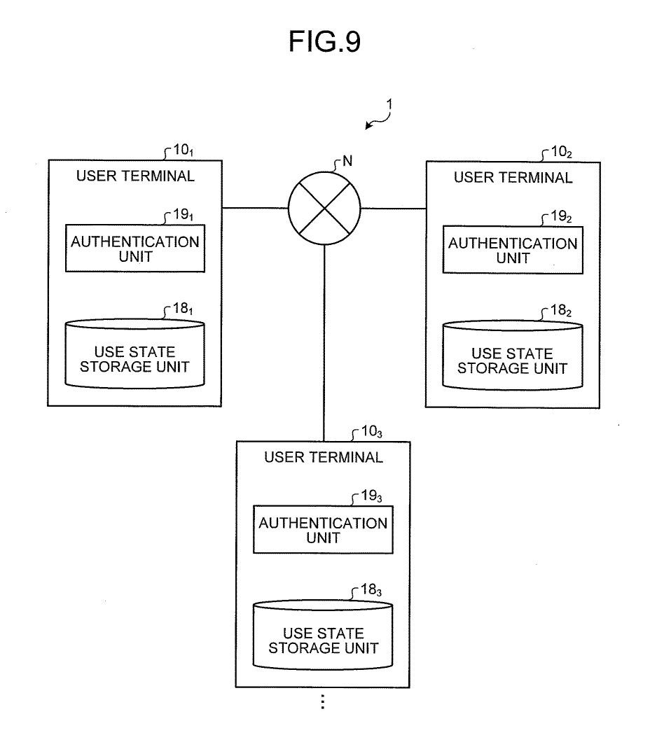

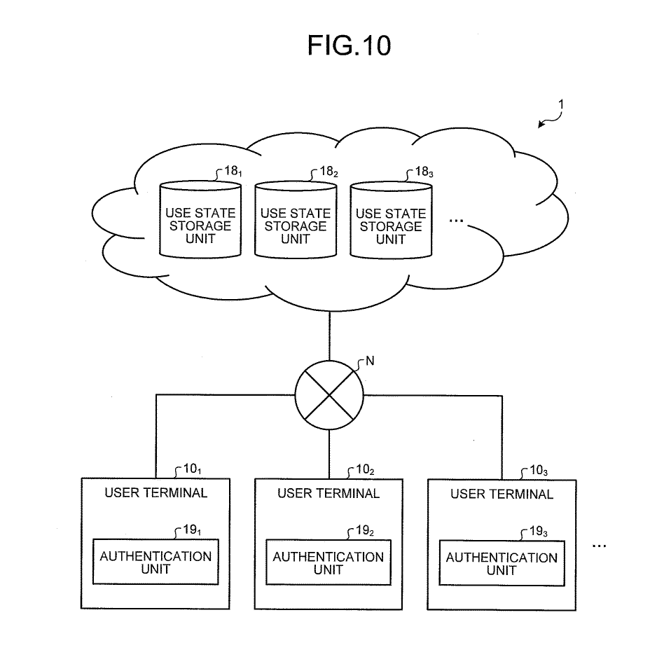

The embodiment described above has exemplified the example in which the authentication device 100 performs the personal authentication of a user based on the information transmitted from the user terminals 10. The authentication processing performed by the authentication device 100 in the embodiment described above may be performed by the user terminals 10. That is, the above-described authentication processing may be performed not through client and server communication using the authentication device 100 as a server and the user terminals 10 as clients, but through communication among the user terminals 10 based on a peer-to-peer system. This point will be described with reference to FIGS. 9 and 10.

FIG. 9 is a diagram (1) illustrating a configuration example of the authentication processing system 1 according to a modification of the embodiment described above. In the example illustrated in FIG. 9, each of the user terminals 10 includes processing units included in the authentication device 100. For example, as illustrated in FIG. 9, a user terminal 10₁ includes a use state storage unit 18₁ and an authentication unit 19₁. In the same manner, a user terminal 10₂ includes a use state storage unit 18₂ and an authentication unit 19₂, and a user terminal 10₃ includes a use state storage unit 18₃ and an authentication unit 19₃.

The user terminal 10₁ stores a use state that the user terminal 10₁ has detected or acquired in the use state storage unit 18₁. The user terminal 10₁ receives a request for authentication from the user. For example, the user terminal 10₁ receives a request from the user, such as a request for a login to the user terminal 10₁ and a request for release of terminal operation lock.

In this case, the user terminal 10₁ communicates with the other user terminals 10₂ and 10₃ through the network N. The authentication unit 19₁ for the user terminal 10₁ performs the personal authentication of the user trying to be authenticated by the user terminal 10₁, based on a combination of use states of the other user terminals 10₂ and 10₃.

For example, the authentication unit 19₁ controls apps installed on the terminals in conjunction with the authentication unit 19₂ for the user terminal 10₂ and the authentication unit 19₃ for the user terminal 10₃ so as to share the use states and the authentication processing with one another. This allows the user terminal 10₁ to perform the same processing as that of the authentication device 100, so that the authentication of the user can be performed without using an external server, such as the authentication device 100 provided with the authentication unit 133 and the use state storage unit 121. While not illustrated in FIG. 9, the processing units, such as the authentication information storage unit 122, included in the authentication device 100 may be included in the user terminal 10₁ (as well as the user terminals 10₂ and 10₃). Processing units of each of the user terminals 10 illustrated in FIG. 3 may perform processing corresponding to that of the processing units of the authentication device 100 illustrated in FIG. 4. For example, the acquisition unit 16 may perform processing corresponding to that of the acquisition unit 131.

Although FIG. 9 illustrates the authentication processing system 1 in the case in which each of the terminals includes the authentication unit and the use state storage unit, such configuration can be variously modified. This point will be described with reference to FIG. 10.

FIG. 10 is a diagram (2) illustrating a configuration example of the authentication processing system 1 according to another modification of the present embodiment. In the example illustrated in FIG. 10, the user terminal 10₁ stores the use state in the use state storage unit 18₁ on a cloud through the network N. Each of the user terminals 10₂ and 10₃ also has the same configuration.

In this case, when performing the authentication processing, the authentication unit 19₁ for the user terminal 10₁ refers to the use state held on the cloud through the network N. The authentication unit 19₁ may refer to the use state storage unit 18₂ and the use state storage unit 18₃ that hold the use states related to the other terminals. In the same manner as in the example illustrated in FIG. 9, the authentication unit 19₁ can perform the personal authentication processing of the user based on the combination of the use states related to the other terminals.

Regarding the example of FIG. 10, the configuration of the user terminal 10₁ (as well as the user terminals 10₂ and 10₃) can be appropriately modified. For example, the user terminal 10₁ may include a storage unit in which the user terminal 10₁ stores the use state thereof other than the use state held on the cloud. For example, the user terminal 10₁ may hold a use state, such as an activity history on websites, in the storage unit on the cloud, and hold information, such as on/off of the screen, a call history, motion, and on/off of the power of the terminal, in the storage unit included in the user terminal 10₁. The user terminal 10₁ may acquire the use states while making determinations on the information for use in the authentication processing, and appropriately changing the source of acquisition of the information for use in the processing among, for example, those on the cloud and the other terminals.

6-2. Modes of Authentication Processing

The embodiment described above has exemplified the example in which the authentication device 100 performs the authentication processing based on the combination of the use states of the terminals, and has exemplified the example in which the authentication device 100 determines, for example, terminals having common information, such as the position information, to be terminals used by the same user. The authentication device 100 may perform the authentication processing based on the combination of the use states of the terminals by asking the user about information that cannot be known by anyone except the user who uses each of the terminals.

For example, assume that the user U1 who owns the smartphone 20 tries to log in to the desktop computer 50. Assume that the authentication device 100 that has received the request for authentication from the desktop computer 50 has information indicating that a user permitted to log in to the desktop computer 50 is the user 111. The authentication device 100 acquires the use state of another terminal (here, the smartphone 20) owned by the user U1.

The authentication device 100 generates a question that cannot be answered by anyone except the user U1 who uses the smartphone 20. For example, the authentication device 100 causes the desktop computer 50 to display a question asking about the number of a destination of a phone call that was made yesterday with the smartphone 20. In this manner, the authentication device 100 generates, and uses in the authentication processing, a question that is difficult for anyone except a user who is trying to log in to the desktop computer 50 and who constantly uses the smartphone 20 to answer. The authentication device 100 successfully completes the personal authentication if the user trying to log in to the desktop computer 50 gives a correct answer to the question. That is, the authentication device 100 determines that the user who gives a correct answer to the question is highly likely to be the user Ul, and successfully completes the personal authentication on the assumption that the user trying to log in to the desktop computer 50 is the user Ul.

In this manner, the authentication device 100 performs the authentication of the user by using, as the combination of the use states of the terminals, a log of a user terminal 10 different from the terminal as a target of authentication. In this manner, the authentication device 100 can perform the highly reliable authentication processing.

The authentication device 100 may generate the question by combining various types of information on the use states acquired from the terminals. For example, if a history of the position information of the smartphone 20 has been acquired, the authentication device 100 may generate a question asking, for example, where the user was at 8 o'clock the previous day, to the user trying to log in to the desktop computer 50. In this case, the authentication device 100 can perform the authentication processing of the user by determining the coincidence between the history of the position information included in the smartphone 20 and an answer received from the user.

The authentication device 100 can generate the question using the use states of not only general communication terminals, but also various devices from which logs are acquirable. For example, if an automobile used by the user has a function to acquire logs and a communication function, the authentication device 100 can generate, for example, a question asking “Did you drive the vehicle in the period from 12 to 18 o'clock on Saturday last week?”, and a question asking about, for example, the start point and the arrival point. If a vacuum cleaner used by the user has a function to acquire logs and a communication function, the authentication device 100 can generate a question asking “Did you use the robotic vacuum cleaner in the morning yesterday?” The authentication device 100 can guarantee a certainty of whether the user trying to be authenticated is the user who has been authenticated in the past by generating a plurality of questions by combining the use states of the above-described devices, and by requesting answers to the questions.

6-3. Use States

The embodiment described above has exemplified the example in which the authentication device 100 acquires, as the use states of the user terminals 10, the information such as the position information, on/off of the screen, on/off of the power, and the moving/stationary state. The authentication device 100 may, however, acquire other information.

For example, the authentication device 100 may acquire the use state of a user terminal 10 acquirable from a dedicated app. As an example, the authentication device 100 can acquire the use state of the smartphone 20 determined by a function of an application programming interface (API) that is included in the smartphone 20 and that can determine activity states of the user, such as walking, stationary, running, and transportations used.

6-4. Identification of Terminals

The embodiment described above has exemplified the example in which the authentication device 100 acquires the terminal IDs in the identification of the user terminals 10. The authentication device 100 need not necessarily acquire global identifiers common to also other devices for identification of the user terminal 10. That is, the authentication device 100 only needs to acquire identifiers that can uniquely identify the respective user terminals 10 in the executed processing, and need not necessarily acquire permanently fixed identifiers.

If, as illustrated in FIGS. 9 and 10, the authentication processing is performed through communication among the user terminals 10, and the processing is performed through one-to-one communication, the terminal IDs need not necessarily be acquired. If the authentication processing is performed through communication among three or more user terminals 10, identifiers capable of uniquely identifying the user terminals 10 only need to be acquired, as described above. For example, the identifiers may be acquired in such a manner that temporary identifiers are issued as appropriate.

6-5. Configuration of Terminal

In the embodiment described above, the configuration example of the user terminal 10 has been described with reference to FIG. 3. However, the user terminal 10 need not necessarily include all the processing units illustrated in FIG. 3. For example, the user terminal 10 need not necessarily include the display unit 13 and the position detection unit 14a. The user terminal 10 may have the configuration illustrated in FIG. 3 in a form divided into two or more devices. For example, the user terminal 10 may be provided using two or more devices by having a configuration divided into a detection device including at least the detection unit 14 and the acquisition unit 16 and a communication device including at least the communication unit 11.

6-6. Authentication Target

The embodiment described above has exemplified the example in which the authentication device 100 performs the personal authentication in the authentication when the user tries to log in to a user terminal 10 to be used. However, the processing performed by the authentication device 100 is not limited to the authentication tried for the user terminal 10 itself.

For example, the authentication device 100 may perform the authentication processing for logins to apps to be executed on the user terminal 10 and for logins to various services provided by web servers. For example, the authentication device 100 performs the authentication processing described above to perform the personal authentication of the user trying to be authenticated into an app. In this case, the authentication device 100 may use a function of the app to acquire information for use in the processing. For example, the authentication device 100 may use the function of the app to acquire, for example, the identification information for identifying the user terminal 10 executing the app and other user terminals 10 owned by the user and the transition of the position information of each of the user terminals 10.

6-7. Anomaly Detection

In the case in which a certain user tries to be authenticated, but sure evidence for personal authentication is not obtained, and thus the authentication device 100 determines that the certain user is not allowed to be authenticated, the authentication device 100 may make notification of the determination.

For example, if the personal authentication fails, the authentication device 100 determines that a user different from the proper user has possibly tried to be authenticated by pretending to be the proper user. The authentication device 100 may give notice of, for example, a warning indicating that the authentication processing has been tried to, for example, other user terminals 10 owned by the user of the user terminal 10 into which the authentication has been tried, or to a service side (such as an administrative server of the service) into which the authentication has been tried.

For example, in the example illustrated in FIG. 1, assume that a user U2 different from the user U1 uses a service ID owned by the user U1 to try to log in to a certain service. In this case, the authentication device 100 acquires use states of a terminal used by the user U2 and other terminals. The authentication device 100 determines that the smartphone 20, the smartglasses 30, and the like constantly carried by the user U1 are not present near the terminal being used by the user U2 for the login. In this case, the authentication device 100 determines that the user U1 and the user U2 are not likely to be the same person, and rejects the personal authentication tried by .the user U2. Furthermore, the authentication device 100 transmits a warning message saying “Someone somewhere is trying to log in with your ID. Take caution.” to the smartphone 20 owned by the user U1. In this manner, when the authentication processing fails, the authentication device 100 determines that an anomaly is detected in the authentication, and thereby can ensure the security of authentication.

7. Hardware Structure

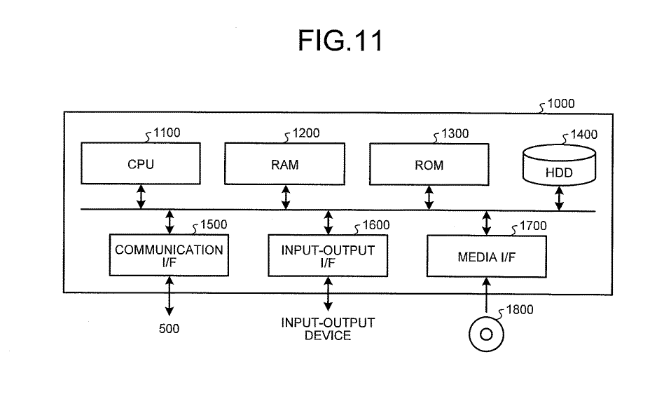

The authentication device 100 according to the present embodiment is achieved by a computer 1000 having the structure illustrated in FIG. 11, for example. The following describes the authentication device 100 as an example. FIG. 11 is a hardware structural diagram illustrating an example of the computer 1000 that achieves the functions of the authentication device 100. The computer 1000 includes a CPU 1100, a RAM 1200, a read-only memory (ROM) 1300, a hard disk drive (HDD) 1400, a communication interface (I/F) 1500, an input-output interface (I/F) 1600, and a media interface (I/F) 1700.

The CPU 1100 operates on the basis of a computer program stored in the ROM 1300 or the HDD 1400 and controls the respective components. The ROM 1300 stores therein a boot program executed by the CPU 1100 when the computer 1000 is booted and computer programs dependent on the hardware of the computer 1000, for example.

The HDD 1400 stores therein computer programs executed by the CPU 1100 and data used by the computer programs, for example. The communication interface 1500 receives data from another apparatus via a communication network 500 (corresponding to the network N illustrated in FIG. 2) and sends the data to the CPU 1100. The communication interface 1500 transmits data produced by the CPU 1100 to another apparatus via the communication network 500.

The CPU 1100 controls output devices such as a display and a printer and input devices such as a keyboard and a mouse via the input-output I/F 1600. The CPU 1100 acquires data from the input devices via the input-output I/F 1600. The CPU 1100 outputs produced data to the output devices via the input-output I/F 1600.

The media I/F 1700 reads a computer program or data stored in a recording medium 1800 and provides the data to the CPU 1100 via the RAM 1200. The CPU 1100 loads the computer program in the RAM 1200 from the recording medium 1800 via the media I/F 1700 and executes the loaded computer program. The recording medium 1800 is an optical recording medium such as a digital versatile disc (DVD) or a phase change rewritable disc (PD), a magneto-optical recording medium such as a magneto-optical disc (MO), a tape medium, a magnetic recording medium, or a semiconductor memory.

For example, when the computer 1000 functions as the authentication device 100 according to the present embodiment, the CPU 1100 of the computer 1000 executes the computer program loaded in the RAM 1200 to achieve the functions of the control unit 130. The HDD 1400 stores therein the data in the storage unit 120. The CPU 1100 of the computer 1000, which reads the computer programs from the recording medium 1800 and executes them, may acquire the computer programs from another device via the communication network 500.

8. Others

In the processes described in the present embodiment, all or a part of the processes described to be automatically performed can also be manually performed. Alternatively, all or a part of the processes described to be manually performed can also be automatically performed by known methods. In addition, the processing procedures, the specific names, and information including various types of data and parameters described in the above description and drawings can be changed as required unless otherwise specified. For example, the various types of information illustrated in the respective drawings are not limited to them.

The components of the illustrated devices are functionally conceptual, and need not necessarily be configured physically as illustrated in the drawings. That is, the specific forms of distribution and integration of the devices are not limited to those illustrated in the drawings, and all or part of the devices can be functionally or physically configured in a distributed or integrated manner in any units according to various loads and states of use. For example, the acquisition unit 131 and the authentication unit 133 illustrated in FIG. 4 may be integrated. For example, the information stored in the storage unit 120 may be stored in an externally provided storage unit through the network N.

For example, the embodiment described above has exemplified the example in which the authentication device 100 performs the acquisition processing to acquire the use states of the user terminal 10 and the authentication processing to personally authenticate the user. However, the authentication device 100 described above may be divided into an acquisition device 200 for performing the acquisition processing and an authentication device 300 for performing the authentication processing. In this case, the acquisition device 200 includes the acquisition unit 131 and the receiving unit 132, and the authentication device 300 includes the authentication unit 133 and the transmission unit 134. In this case, the processing performed by the authentication device 100 according to the present embodiment is performed by the authentication processing system 1 that includes the devices, such as the acquisition device 200 and the authentication device 300.

The embodiments and modifications described above can be combined as appropriate without inconsistency among them.

9. Advantageous Effects

As described above, the authentication device 100 according to the embodiment described above includes the acquisition unit 131 and the authentication unit 133. The acquisition unit 131 acquires the use states in the user terminals 10 used by the user. The authentication unit 133 authenticates the user based on the combination of the use states of the user terminals 10 acquired by the acquisition unit 131.

In this manner, the authentication device 100 according to the present embodiment performs the authentication processing based on the combination of the user terminals 10. That is, the authentication device 100 identifies a user who handles each of the user terminals 10 using, for example, commonality among the use states of the terminals, and thereby can perform the highly reliable personal authentication. The authentication device 100 automatically acquires the use states of the user terminals 10 owned by the user, and performs the highly reliable authentication processing without the need for the user to enter a password or the like. Consequently, the user can be subjected to the authentication processing without the need for a particular operation. In this manner, the authentication device 100 can reduce the burden related to the authentication while maintaining the security of authentication.

At least one of the user terminals 10 from which the use state is acquired by the acquisition unit 131 is a portable terminal device portable by the user. The authentication unit 133 authenticates the user based on the combination of the use states of the user terminals 10 including the portable terminal device.

In this manner, the authentication device 100 can acquire the motion and the position information of the user by acquiring the use state of what is called the mobile terminal. In this manner, the authentication device 100 can perform the authentication processing by using more useful information than that of a user terminal 10 normally placed at a certain place.

The acquisition unit 131 acquires the use states within the predetermined period of time until the time of receiving of the request for authentication. The authentication unit 133 authenticates the user based on the combination of the use states of the user terminals 10 within the predetermined period of time acquired by the acquisition unit 131.

That is, the authentication device 100 performs the authentication processing using the use states until the authentication processing is performed, such as the information on the traveling path of the user until the authentication processing is performed and the position information. As a result, the authentication device 100 can correctly determine whether the user terminals 10 have the common position information until the authentication processing is performed, and thereby can accurately perform the personal authentication.

The acquisition unit 131 acquires the use states of the user terminals 10 present within the predetermined geographical area from the transmission source of the request for authentication (such as the terminal as a target of authentication). The authentication unit 133 authenticates the user based on the combination of the use states of the user terminals 10 within the predetermined geographical area acquired by the acquisition unit 131.

That is, the authentication device 100 performs the authentication processing using the use states of the user terminals 10 in the vicinity of the geographical point where the authentication processing is performed. For example, the authentication device 100 uses the user terminals 10 near the terminal as a target of authentication. Hence, the authentication device 100 can acquire the use states of user terminals 10 that are highly likely to be handled by the proper user, and can perform the authentication processing. In this manner, the authentication device 100 can perform the highly accurate authentication processing.

The acquisition unit 131 acquires the states of communication of the user terminals 10 as the use states. The authentication unit 133 authenticates the user based on the states of communication of the user terminals 10 acquired by the acquisition unit 131.

That is, the authentication device 100 can acquire the states of communication in which more than one of the user terminals 10 are, for example, identified on the same local network as that of the terminal as a target of authentication, or communicating via the same external networking equipment. If such a communication is established, the user terminals 10 are assumed to be highly likely to be owned or used by the same user. The authentication device 100 can perform the highly accurate personal authentication by performing the processing based on such states of communication as described above.

The acquisition unit 131 acquires, as the states of communication of the user terminals 10, states of communication in which the user terminals 10 directly communicate with one another without using external networking equipment as an intermediary. The authentication unit 133 authenticates the user based on the states of communication that have been acquired by the acquisition unit 131 and in which the user terminals 10 directly communicate with one another.

In this manner, the authentication device 100 can acquire the state of direct communication among the user terminals 10 as a type of communication. For example, the authentication device 100 can acquire the use states in which, for example, a certain short-range communication is established among the user terminals 10. If such a communication is established, the user terminals 10 are assumed to be terminals highly likely to be used by the same user. The authentication device 100 can perform the highly accurate personal authentication by performing the processing based on such states of communication among the user terminals 10 as described above.

The acquisition unit 131 acquires, as the use states, states of periodical communication among the user terminals 10, or states of periodical communication between the user terminals 10 and a particular access point. The authentication unit 133 authenticates the user based on the states of periodical communication among the user terminals 10, or on the states of periodical communication between the user terminals 10 and the particular access point, the states of periodical communication having been acquired by the acquisition unit 131 until the time of receiving of the request for authentication.

In this manner, the authentication device 100 acquires the information indicating what kinds of devices communicate with the user terminals 10. For example, the user terminals 10 that often communicate with a particular common access point are assumed to be terminals highly likely to be used by the same user. The authentication device 100 can perform the highly accurate personal authentication by performing the processing based on such states of communication as described above.

The acquisition unit 131 acquires the past use states in the user terminals 10 until the time of receiving of the request for authentication. The authentication unit 133 authenticates the user based on the similarity between the past use states acquired by the acquisition unit 131 and the use states at the time of receiving of the request for authentication.

In this manner, the authentication device 100 determines, for example, the similarity between the use states of the user terminals 10 observed in the past and the use states of the user terminals 10 at the time when the authentication processing has been tried. That is, the authentication device 100 identifies the proper user based on, for example, the behavioral characteristics of the user derived from a plurality of terminals, and thereby can perform the highly accurate personal authentication.

The acquisition unit 131 acquires, from the user terminals 10, the information on the user terminals 10 detected by the user terminals 10 themselves as the use states. The authentication unit 133 authenticates the user by using the information on the user terminals 10 acquired by the acquisition unit 131.

In this manner, the authentication device 100 can use the information acquired by, for example, the sensors included in the user terminal 10 as the use states for use in the processing. As a result, the authentication device 100 can acquire various types of information as the use states, and thereby can perform the personal authentication of the user from multiple angles, without depending on a small number of particular determining factors.

The acquisition unit 131 acquires at least one of the following: the histories of operations of the user terminals 10 by the user, the information on the times of the operations of the user terminals 10 by the user, and the information detected by the user terminals 10. The authentication unit 133 authenticates the user based on the context of the user inferred based on the information acquired by the acquisition unit 131.

In this manner, the authentication device 100 infers the context of the user based on the various types of information acquirable from the user terminals 10. The authentication device 100 performs the personal authentication based on the similarity of the inferred context of the user. In this manner, the authentication device 100 can perform a variety of types of authentication processing, such as the authentication based on the similarity in the life pattern of the user, without depending on particular information.

The acquisition unit 131 acquires the position information representing the positions of the user terminals 10 as the use states. The authentication unit 133 authenticates the user based on the similarity in transition of the position information of the terminal devices until the time of receiving of the request for authentication.

In this manner, the authentication device 100 acquires the position information, such as the paths along which the user terminals 10 have traveled. If a plurality of user terminals 10 have simultaneously traveled along the same path, such user terminals 10 are assumed to be terminals that are highly likely to be used by the same user. The authentication device 100 can perform the highly accurate personal authentication by performing the processing based on the similarity of the position information as described above.

The authentication unit 133 generates a question about the use states acquired by the acquisition unit 131, and authenticates the user based on an answer from the user to the generated question.

In this manner, the authentication device 100 can perform the personal authentication processing by asking the user the question that cannot be answered by anyone except the user who uses the user terminals 10. In this manner, the authentication device 100 can perform the highly secure authentication processing.

The processing described above may be carried out by the user terminals 10, instead of by the authentication device 100. That is, any user terminal 10 of the user terminals 10 used by the user includes the acquisition unit 16 that acquires the use states in the user terminals 10 and the authentication unit 19 that authenticates the user based on the combination of the use states of the user terminals 10 acquired by the acquisition unit 16.

In this manner, the user terminals 10 can perform the authentication of the user by sharing the use states among the user terminals 10, and performing the authentication processing with one another. In this manner, the user terminals 10 can perform the authentication processing excellent in security and convenience without using an external server, such as the authentication device 100.

Some embodiments of the present application are described in detail with reference to the accompanying drawings by way of example. The present invention can be implemented in other embodiments changed or modified on the basis of the knowledge of the persons skilled in the art, besides the embodiments described herein.

The term “unit” described above can be replaced with a “section”, a “module”, or a “circuit”, for example. For example, the acquisition unit can be replaced with an acquisition section or an acquisition circuit.

According to an aspect of an embodiment, an advantageous effect is provided that the security of authentication can be ensured.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An authentication device comprising:
an acquisition unit that acquires use states in a plurality of terminal devices used by a user; and
an authentication unit that authenticates the user based on a combination of the use states of the terminal devices acquired by the acquisition unit.

2. The authentication device according to claim 1, wherein
at least one of the terminal devices from which a use state is acquired by the acquisition unit is a portable terminal device portable by the user, and
the authentication unit authenticates the user based on the combination of the use states of the terminal devices including the portable terminal device.

3. The authentication device according to claim 1, wherein
the acquisition unit acquires the use states of the terminal devices within a predetermined period of time until a time when a request for authentication is received, and
the authentication unit authenticates the user based on the combination of the use states of the terminal devices within the predetermined period of time acquired by the acquisition unit.

4. The authentication device according to claim 1, wherein
the acquisition unit acquires the use states of the terminal devices present within a predetermined geographical area from a transmission source of a request for authentication, and
the authentication unit authenticates the user based on the combination of the use states of the terminal devices present within the predetermined geographical area acquired by the acquisition unit.

5. The authentication device according to claim 1, wherein
the acquisition unit acquires states of communication of the terminal devices as the use states, and
the authentication unit authenticates the user based on the states of communication of the terminal devices acquired by the acquisition unit.

6. The authentication device according to claim 5, wherein
the acquisition unit acquires, as the states of communication of the terminal devices, states of communication in which the terminal devices directly communicate with one another without using external networking equipment as an intermediary, and
the authentication unit authenticates the user based on the states of communication acquired by the acquisition unit in which the terminal devices directly communicate with one another.

7. The authentication device according to claim 5, wherein
the acquisition unit acquires, as the use states, states of periodical communication among the terminal devices, or states of periodical communication between the terminal devices and a particular access point, and
the authentication unit authenticates the user based on the states of periodical communication among the terminal devices, or on the states of periodical communication between the terminal devices and the particular access point, the states of periodical communication having been acquired by the acquisition unit until a time when a request for authentication is received.

8. The authentication device according to claim 1, wherein
the acquisition unit acquires past use states in the terminal devices until a time when a request for authentication is received, and
the authentication unit authenticates the user based on a similarity between the past use states acquired by the acquisition unit and the use states at the time of receiving of the request for authentication.

9. The authentication device according to claim 1, wherein
the acquisition unit acquires, from the terminal devices, information on the terminal devices detected by the terminal devices themselves as the use states, and
the authentication unit authenticates the user based on the information on the terminal devices acquired by the acquisition unit.

10. The authentication device according to claim 1, wherein
the acquisition unit acquires at least one of: histories of operations of the terminal devices by the user, information on times of the operations of the terminal devices by the user, and information detected by the terminal devices, and
the authentication unit authenticates the user based2 on a context of the user inferred based on the information acquired by the acquisition unit.

11. The authentication device according to claim 1, wherein
the acquisition unit acquires position information representing positions of the terminal devices as the use states, and
the authentication unit authenticates the user based on a similarity in transition of the position information of the terminal devices until a time when a request for authentication is received.

12. The authentication device according to claim 1, wherein
the authentication unit generates a question about the use states acquired by the acquisition unit, and authenticates the user based on an answer to the generated question.

13. A terminal device of any one of a plurality of terminal devices used by a user, the terminal device comprising:
an acquisition unit that acquires use states in the terminal devices, and
an authentication unit that authenticates the user based on a combination of the use states of the terminal devices acquired by the acquisition unit.

14. An authentication method executed by a computer, the method comprising:
acquiring use states in a plurality of terminal devices used by a user, and
authenticating the user based on a combination of the use states of the terminal devices acquired at the acquiring.

15. A non-transitory computer readable storage medium having stored therein an authentication program for causing a computer to execute a procedure comprising:
acquiring use states in a plurality of terminal devices used by a user, and
authenticating the user based on a combination of the use states of the terminal devices acquired at the acquiring.
